(19) United States
(12) Patent Application Publication
(10) Pub. No.: US 2025/0223204 A1
(43) Pub. Date: Jul. 10, 2025

(54) METHOD AND DEVICE FOR TREATING WATER SUPPLY WELLS

(71) Applicant: SAUDI ARABIAN OIL COMPANY, Dhahran (SA)

(72) Inventors: Tao Chen, Dhahran (SA); Qiwei Wang, Dhahran (SA)

(73) Assignee: SAUDI ARABIAN OIL COMPANY, Dhahran (SA)

(21) Appl. No.: 18/408,806

(22) Filed: Jan. 10, 2024

(51) Int. Cl. C02F 1/68; E21B 23/01; E21B 27/00

(52) U.S. Cl. CPC C02F 1/685; E21B 23/01; E21B 27/00; C02F 2303/04; C02F 2303/08; C02F 2303/22

(57) ABSTRACT

A device for treating water supply wells includes a gauge hanger with an attachment piece at a bottom end of the gauge hanger and at least one permeable container connected to the gauge hanger via the attachment piece. The permeable container includes a top portion with top openings, a bottom portion with bottom openings, and a connecting portion connecting the top portion to the bottom portion. A method for treating a water supply well includes placing an encapsulated treatment chemical in at least one permeable container and placing a device in the water supply well where the device includes a gauge hanger and the at least one permeable container. The method may include treating a water supply by flowing produced fluid through the bottom openings and top openings of the permeable container which introduces the treatment chemical into the water supply.

### BACKGROUND

Metal loss due to corrosion attack is an expensive and persistent issue faced in water supply wells in the oil and gas industry, especially in downhole tubulars in high temperature water supply wells. Inhibition chemicals, i.e., film-forming corrosion inhibitors, have been approved as the most cost-effective solutions to protect system integrity. Corrosion inhibitors are conventionally applied by continuous injection and/or batch treatment. Continuous injection application requires high capital expenditure and extensive maintenance. Batch treatment uses large quantity of inhibitors but very short treatment life due to the stripping off of the inhibitor film formed initially by water. For matured water supply wells, the corrosion inhibitor could enter the near-wellbore reservoir and cause formation damage and loss of productivity. Accordingly, there exists a need for a corrosion inhibition treatment method that is simple, economical, and supplies a suitable quantity of inhibitors over an extended period of time.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a device for treating water supply wells. The device may include a gauge hanger with an attachment piece at a bottom end of the gauge hanger and at least one permeable container connected to the gauge hanger via the attachment piece. The permeable container may include a top portion with top openings, a bottom portion with bottom openings, and a connecting portion connecting the top portion to the bottom portion.

In another aspect, embodiments disclosed herein relate to a method for treating a water supply well including placing an encapsulated treatment chemical in at least one permeable container and placing a device in the water supply well where the device may include a gauge hanger and the least one permeable container. The at least one permeable container may include a top portion with top openings, a bottom portion with bottom openings, and a connecting portion connecting the top portion to the bottom portion. The method for treating the water supply well may include treating a water supply by flowing produced fluid through the bottom openings and top openings which may introduce the treatment chemical into the water supply.

Other aspects and advantages of the claimed subject matter will be apparent from the following description and the appended claims.

### BRIEF DESCRIPTION OF DRAWINGS

FIG. 1 is a depiction of a well environment in accordance with one or more embodiments of the present disclosure.

FIG. 2 is a depiction of a device in accordance with one or more embodiments of the present disclosure.

FIG. 3 is a depiction of a gauge hanger in accordance with one or more embodiments of the present disclosure.

FIG. 4A is a depiction of a permeable container in accordance with one or more embodiments of the present disclosure.

FIG. 4B is a depiction of a permeable container in accordance with one or more embodiments of the present disclosure.

FIG. 5A is a top-down depiction of a top portion of a permeable container in accordance with one or more embodiments of the present disclosure.

FIG. 5B is a top-down depiction of a bottom portion of a permeable container in accordance with one or more embodiments of the present disclosure.

FIG. 6 is a zoomed in view of a connecting portion of a permeable container with side openings in accordance with one or more embodiments of the present disclosure.

FIG. 7 is a depiction of a gauge hanger with two permeable containers in accordance with one or more embodiments of the present disclosure.

### DETAILED DESCRIPTION

Embodiments in accordance with the present disclosure generally relate to a device for treating water supply wells and a method of using the device for treating water supply wells. The treatment may relate to corrosion inhibition or scale prevention. The device may provide an encapsulated treatment chemical in one or more permeable containers with openings which allow produced fluids to flow through. The flow may dispense the treatment chemical into the water supply to treat the water supply well.

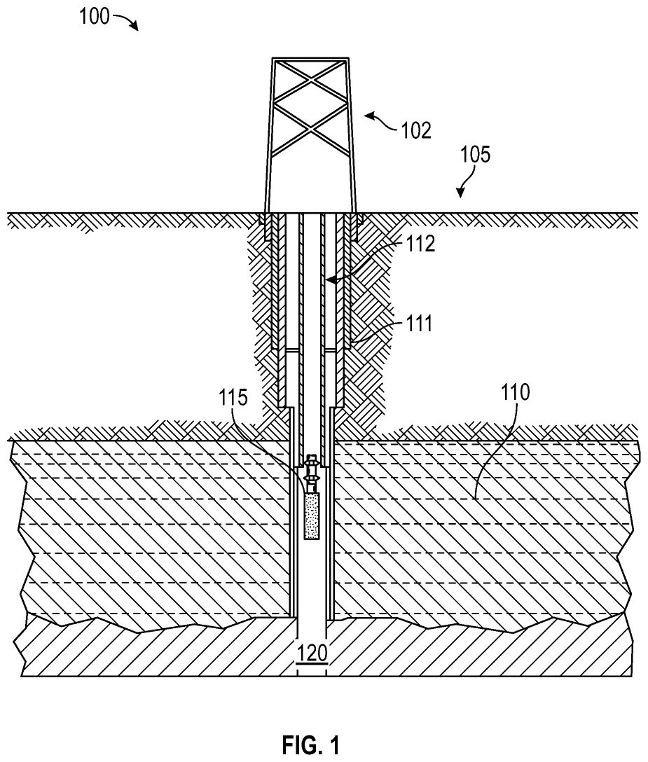

FIG. 1 illustrates a well environment 100 in accordance with one or more embodiments of the present disclosure. Well environment 100 includes surface 105 and subsurface 110. Subsurface 110 is depicted having a wellbore wall 111 that extends downhole from surface 105 into subsurface 110 and defines a wellbore 120. A casing 112 is positioned in the wellbore 120. The well environment includes wellhead 102 at surface 105. A device 115 is placed in the wellbore 120. The device 115 includes a gauge hanger and at least one permeable container. The at least one permeable container may contain an encapsulated treatment chemical for treating a water supply well.

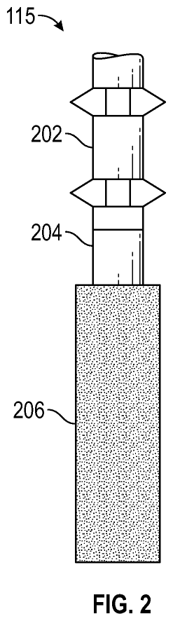

FIG. 2 depicts a device 115 in accordance with one or more embodiments of the present disclosure. The device 115 may include a gauge hanger 202. The device may further include a permeable container 206 connected to the gauge hanger. The gauge hanger 202 includes an attachment piece 204 for connecting the gauge hanger 202 to the permeable container 206.

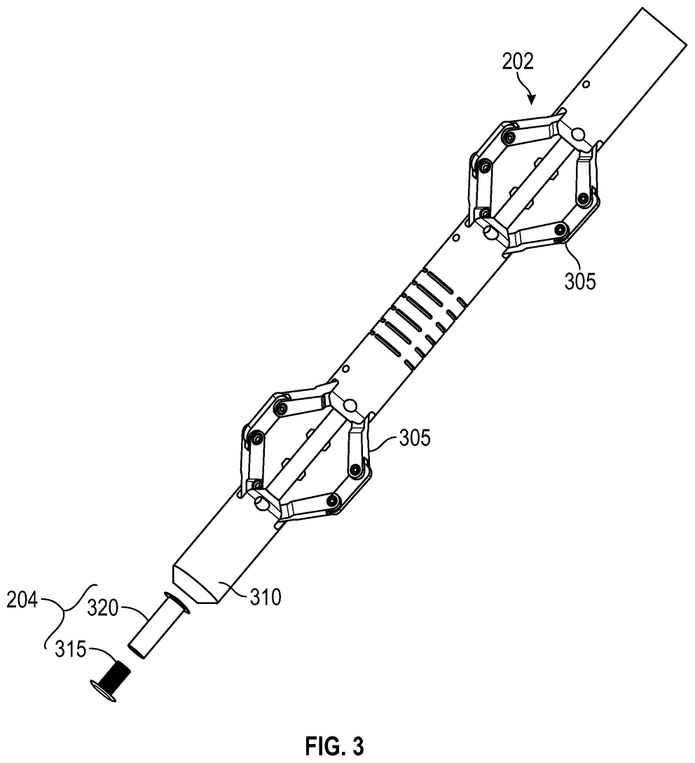

FIG. 3 depicts a gauge hanger 202 in accordance with one or more embodiments of the present disclosure. The gauge hanger 202 may be a downhole hanger or a fishing neck that may be used to suspend a permeable container. The gauge hanger 202 is an elongated member that includes radial extendable arms 305. The radial extendable arms 305 may allow for the gauge hanger 202 to anchor in the wellbore. The radial extendable arms 305 may be adjusted to the width of the well at the desired depth for anchoring. The desired depth may range from 200 to 7000 ft. For example, the desired depth may have a lower limit of one of any of 200, 500, 1000, 1500, 2000, 2500, 3000, and 3500 ft with an upper limit of one of any of 3500, 4000, 4500, 5000, 6000, and 7000 ft, where any lower limit may be combined with any mathematically compatible upper limit. The gauge hanger 202 may be any commercial gauge hanger suitable for use in a water supply well. Non-limiting examples include high expansion gauge hangers which are commercially available from suppliers such as Interwell and Halliburton.

The gauge hanger may include an attachment piece 204. The attachment piece 204 may be a female connector 320 at the end of the gauge hanger 202 that connects to a male screw 315 of the permeable container 206. The male screw 315 may be attached to a top portion 404 of the permeable container 206. The attachment piece 204 may be attached to the gauge hanger 202 at a bottom end 310. In one or more embodiments, the attachment piece 204 is made of stainless steel, Hastelloy, and combinations thereof. The diameter of the attachment piece 204 may be from 1 to 2 inches. The permeable container 206 may be disconnected from the gauge hanger 202 via the attachment piece 204. Disconnection may occur when the female connector 320 is released from the male screw 315.

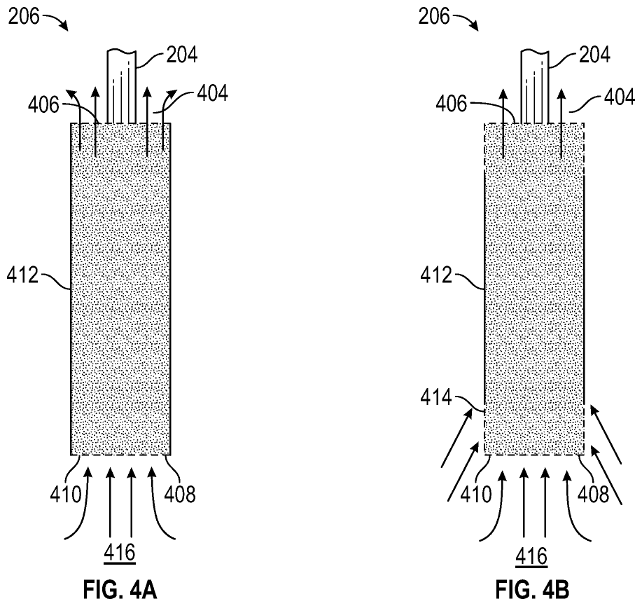

FIG. 4A depicts a side view of a permeable container 206 in accordance with one or more embodiments of the present disclosure. The permeable container 206 includes an attachment piece 204. The attachment piece 204 attaches the permeable container 206 to the gauge hanger 202.

The permeable container 206 may be made of a corrosion resistant alloy. In one or more embodiments, the permeable container 206 is made of stainless steel, Hastelloy, and combinations thereof.

The permeable container 206 includes a top portion 404 and a bottom portion 408. The top portion 404 and the bottom portion 408 are connected by a connecting portion 412. In one or more embodiments, the top portion 404 and the bottom portion 408 have the same dimensions. The shape of the top portion 404 and bottom portion 408 may be any shape suitable for a container. For example, the shape may be circular, square, or rectangular. In one or more embodiments, the top portion 404 and bottom portion 408 are circular with a diameter ranging from 2 to 6 inches. For example, the diameter may have a lower limit of one of any of 2, 2.5, 3, 3.5, and 4 inches with an upper limit of one of any of 4, 4.5, 5, 5.5 and 6 inches, where the lower limit may be combined with any mathematically compatible upper limit. The top portion 404 and bottom portion 408 may have a thickness ranging from 5 to 30 millimeters (mm). For example, the thickness may have a lower limit of one of any of 5, 10, 15, and 20 mm with an upper limit of one of any of 20, 25, and 30 mm, where the lower limit may be combined with any mathematically compatible upper limit. In one or more embodiments, both the top portion 404 and the bottom portion 408 are removable from the permeable container 206.

The top portion 404 and the bottom portion 408 of the at least one permeable container 206 are connected by a connecting portion 412. Thus, the connecting portion 412 may also be referred to as the side or sides of the container. The connecting portion 412 may connect the top portion 404 and the bottom portion 408 in a manner that the permeable container 206 may have a length ranging from 1 to 30 ft. For example, the length may have a lower limit of one of any 1, 2, 5, 10, and 15 ft with an upper limit of one of any of 15, 20, 25, and 30 ft, where any lower limit may be combined with any mathematical upper limit. The connecting portion 412 may have a thickness ranging from 5 to 30 mm.

The top portion 404 of the permeable container 206 includes top openings 406. As described herein, “openings” refers to holes or pores in the container that allow for fluid to flow therethrough. The top openings 406 may be of a density and diameter to allow for controlling the flow of produced fluids 416 from the water supply well through the permeable container 206. The top openings 406 may also be of a diameter that prevents the encapsulated treatment chemical from leaving the at least one permeable container 206. The top portion 404 may include a density of top openings 406 ranging from 4 to 400 openings per centimeter squared (cm²). For example, the density of top openings 406 may have a lower limit of one of any of 4, 10, 50, 100, and 200 openings per cm² and an upper limit of one of any of 200, 250, 300, 350, and 400 openings per cm², where any lower limit may be combined with any mathematically compatible upper limit. The top openings 406 may have a diameter ranging from 0.5 to 5 mm. For example, the diameter may have a lower limit of one of any of 0.5, 1, 1.5, 2 and 2.5 mm with an upper limit of one of any of 2.5, 3, 3.5, 4, 4.5, and 5 mm, where any lower limit may be combined with any mathematically compatible upper limit. The density of the top openings 406 may be optimized for the permeable container 206 based upon the resulting concentration of a treatment chemical measured in produced fluids from an encapsulated treatment chemical provided by the permeable container 206. If the concentration is lower than desired, the density of the top openings 406 may be increased in the permeable container 206. The desired concentration of the treatment chemical is described in greater detail below.

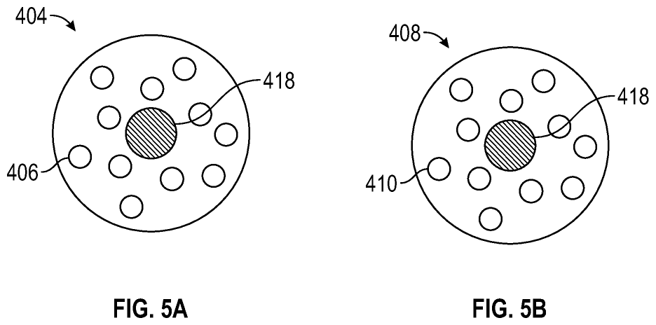

FIG. 5A depicts a top-down view of the top portion 404 in accordance with one or more embodiments. The top portion 404 may include an attachment area 418 that connects to the attachment piece 204 and the top openings 406 as previously described.

Referring back to FIG. 4A, the permeable container 206 includes a bottom portion 408 with bottom openings 410. The bottom openings 410 may be of a density and diameter to allow for controlling the flow of produced fluids 416 from the water supply well through the permeable container 206. The bottom openings 410 may also be of a diameter that prevents the encapsulated treatment chemical from leaving the permeable container 206. The bottom portion 408 may include a density of bottom openings 410 ranging from 4 to 400 openings per cm². For example, the density of bottom openings 410 may have a lower limit of one of any of 4, 10, 50, 100, and 200 openings per cm² and an upper limit of one of any of 200, 250, 300, 350, and 400 openings per cm², where any lower limit may be combined with any mathematically compatible upper limit. The bottom openings 410 may have a diameter ranging from 0.5 to 5 mm. For example, the diameter may have a lower limit of one of any of 0.5, 1, 1.5, 2 and 2.5 mm with an upper limit of one of any of 2.5, 3, 3.5, 4, 4.5, and 5 mm, where any lower limit may be combined with any mathematically compatible upper limit. The density of the bottom openings 410 may be optimized for the permeable container 206 based upon the resulting concentration of a treatment chemical measured in produced fluids from an encapsulated treatment chemical provided by the permeable container 206. If the concentration is lower than desired, the density of the bottom openings 410 may be increased in the permeable container 206. The desired concentration of the treatment chemical is described in greater detail below.

FIG. 5B depicts a top-down view of the bottom portion 408 in accordance with one or more embodiments. The bottom portion 408 includes bottom openings 410. The top openings 406 and bottom openings 410 together may control the flow of produced fluids 416 from the water supply well through the at least one permeable container 206. The bottom portion 408 may, in some embodiments, include an attachment area 418 that connects to the attachment piece 204. In such embodiments, more than one permeable container is included in the device, as described in greater detail below.

In the embodiment shown in FIG. 4A, the connecting portion 412 does not include any openings but is a continuous solid material. FIG. 4B depicts another embodiment of a permeable container 206 as previously described. In the embodiment shown in FIG. 4B, the connecting portion 412 has side openings 414. The side openings 414 may be of a density and diameter to allow for controlling the flow of produced fluids 416 from the water supply well through the permeable container 206. The side openings 414 may also be of a diameter that prevents the encapsulated treatment chemical from leaving the at least one permeable container 206. The connecting portion 412 may include a density of side openings 414 ranging from 4 to 400 openings per cm². For example, the density of side openings 414 may have a lower limit of one of any of 4, 10, 50, 100, and 200 openings per cm² and an upper limit of one of any of 200, 250, 300, 350, and 400 openings per cm², where any lower limit may be combined with any mathematically compatible upper limit. The side openings 414 may have a diameter ranging from 0.5 to 5 mm. The density of the side openings 414 may be optimized for the permeable container 206 based upon the resulting concentration of a treatment chemical measured in produced fluids from an encapsulated treatment chemical provided by the permeable container 206. If the concentration is lower than desired, the density of the side openings 414 may be increased in the permeable container 206. The desired concentration of the treatment chemical is described in greater detail below. The top openings 406 and bottom openings 410 together with the side openings 414 on the connecting portion 412 may control the flow of produced fluids 416 from the water supply well through the at least one permeable container 206.

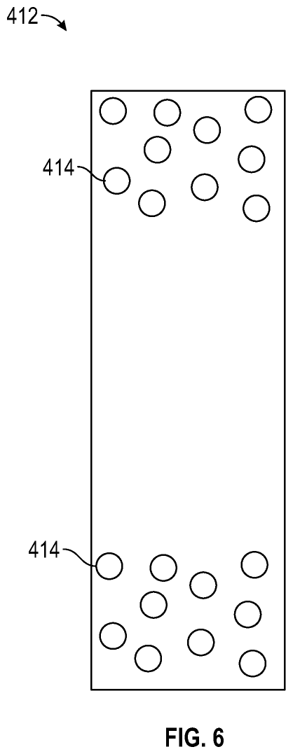

The connecting portion 412 according to one or more embodiments is further depicted in FIG. 6. The connecting portion 412 may include side openings 414. In one or more embodiments, the side openings 414 are present along the top and bottom of the connecting portion. For example, the side openings 414 are present in the top 0.2 to 2 ft of the connecting portion 412. The side openings 414 are also present in the bottom 0.2 to 2 ft of the connecting portion 412. The density of side openings 414 may be adjusted to control the flow of the produced fluids through the permeable container. The density of the side openings 414 may be optimized for the permeable container 206 based upon the resulting concentration of a treatment chemical measured in produced fluids from an encapsulated treatment chemical provided by the permeable container 206. If the concentration is lower than desired, the density of the side openings 414 may be increased in the permeable container 206. The desired concentration of the treatment chemical is described in greater detail below.

Produced fluids (indicated by arrows 416) from the water supply well may flow in through the bottom openings 410 (and optionally the side openings 414) and into the permeable container 206 to contact the encapsulated treatment chemical. The contact between the produced fluids and the encapsulated treatment chemical may result in the treatment chemical diffusing into the produced fluids 416. Then the produced fluids 416 with the treatment chemical may flow out through the top openings 406 and into the water supply well.

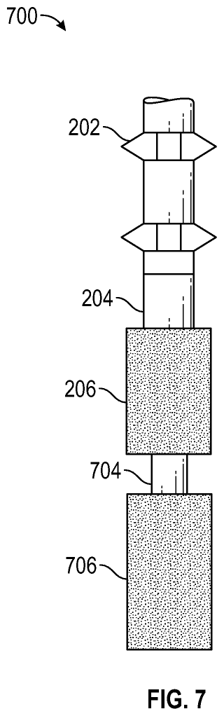

In one or more embodiments, two permeable containers are included with the gauge hanger. A device with two permeable containers is depicted in FIG. 7. The device 700 includes a gauge hanger 202 and a permeable container 206 as previously described. The permeable container 206 is attached to the gauge hanger 202 with an attachment piece 204 as previously described. According to one or more embodiments, a second permeable container 706 is included in the device 700. The second permeable container 706 is attached in series to the permeable container 206 by a second attachment piece 704. The second attachment piece 704 may be a male screw with a diameter of 1 to 2 inches attached to the top of the second permeable container 706. The bottom of the permeable container 206 may include a female connector with a diameter of 1 to 2 inches. The female connector of the permeable container 206 may then be connected by the male screw of the second attachment piece 704 on the top of the second permeable container 706. Each permeable container may contain top openings and bottom openings of a different density and diameter for controlling the flow of produced fluids through each permeable container from the water supply well. The density and diameter of openings may be selected based on the desired amount of treatment chemical to be dispensed into the water supply well. The density and diameter of openings may be different in each permeable container. In one or more embodiments, each of the two permeable containers includes a different encapsulated treatment chemical. The density of the openings may be adjusted based on the resulting concentration of each treatment chemical measured in produced fluids from each encapsulated treatment chemical. As previously described, if the concentration is lower for each treatment chemical than desired, the density of openings may be increased in each permeable container. The desired concentration for each treatment chemical is described in greater detail below.

Embodiments of the present disclosure are further directed to a method for treating a water supply well. The method may include placing an encapsulated treatment chemical in at least one permeable container. The permeable container may contain a top portion, a bottom portion, and a connecting portion, as previously described. In one or more embodiments, the top portion is removable so that the encapsulated treatment chemical may be placed inside the permeable container. After placing the encapsulated treatment chemical, the top portion may be returned to the permeable container. The volume of encapsulated treatment chemical placed in the at least one permeable container may depend on the dosage of treatment chemical required. The total volume of the permeable container may range from 0.618 to 74 liters (L). The permeable may be partially or fully loaded with the treatment chemical. As such, the volume of encapsulated treatment chemical placed in the at least one permeable container may range from 0.618 to 74 liters (L). For example, the volume of encapsulated treatment chemical may have a lower limit of one of any of 0.618, 1, 5, 10, 20, 30, and 37 L with an upper limit of one of any of 37, 40, 45, 50, 60, 70, and 74 L, where any lower limit may be combined with any mathematically compatible upper limit. The encapsulated treatment chemical may be a liquid chemical encapsulated in a polymer cells. The encapsulated chemicals may also be a solid chemical deposited in porous encapsulated materials.

The treatment chemical may be a corrosion inhibitor, a scale inhibitor, a biocide, or combinations thereof. Such treatment chemicals (and their encapsulated counterparts) are well known in the art, and commercially available.

Corrosion inhibitors may include a group of imidazoline, imidazole, quinoline, pyridine, and their derivatives, primary/secondary/tertiary/quaternary amines, n-dodecylamine, N—N-dimethyl dodecylamine, amide, amidoamine, amidoimidazoline, isoxazolidine, succinic acid, carboxylic acid, aldehyde, alkanolamine, imidazoline-imidazolidine compound, α,β-ethylene unsaturated aldehyde, polyalkylenepolyamine, diethylenetriamine, and mixtures thereof.

Scale inhibitors may include polyphosphate, 1-hydroxyethylidenediphosphonic acid (HDEP), ethane-1,2-diphosphonic acid (EDPA), diethylenetriaminepenta(methylenephosphonic acid) (DETPMP), tris(phosphonomethyl)amine, nitrilotrimethylphosphonic acid, aminotris(methylphosphonic acid) (ATMP), bis(hexamethylenetriaminepenta(methylenephosphonic acid)) (BHTMP), 1-hydroxyethylidene-1,1-diphosphonic acid (HEDP), [[(2-hydroxyethyl)imino]bis(methylene)]bisphosphonic acid (MEA/HADMP), polyacrylic acid (PAA), polymaleic acid (PMA), polyphosphinocarboxylic acid (PPCA), polyvinyl sulfonate and polyacrylic acid copolymer (PVS), phosphonocarboxylic acid (POCA) and 2-phosphono-butane-1, 2, 4-tricarboxylic acid (PBTC), polyamino polyether methylene phosphonae (PAPEMP), polyaspartate, and mixtures thereof.

Biocides may include glutaraldehyde, tetrakis(hydroxymethyl)phosphonium sulfate (THPS), alkyldimethylbenzylammonium chloride (ADBAC), didecyldimethylammonium chloride (DDAC), tributyl(tetradecyl)phosphonium chloride (TTPC), cocodiamine, 2,2-dibromo-3-nitrilopropionamide (DBNPA), 2-bromo-2-nitro-1,3-propanediol, tetrahydro-3,5-dimethyl-2H-1,3,5-thiadiazinethione, 5-chloro-2-methyl-4-isothiazolin-3-one+2-methyl-4-isothiazolin-3-one (CMJT/MJT), 4,4-dimethyloxazolidine (DMO), 1-(3-chloroallyl)-3,5,7-triaza-1-azoniaadamantane chloride (CTAC), tris(hydroxymethyl)nitromethane (THNM), sodium hypochlorite, ozone, chlorine dioxide, peracetic acid, and mixtures thereof.

The method according to one or more embodiments may include encapsulating one or more of the previously described treatment chemicals before placing the encapsulated treatment chemical in the at least one permeable container. The material encapsulating the treatment chemical may also be referred to as an encapsulant. The treatment chemical may be encapsulated by a method of precipitation of the treatment chemical and multivalent cations such as calcium, magnesium, barium, strontium, aluminum, and combinations thereof. In one or more embodiments, the treatment chemical is encapsulated in an amount in the range of 0.05 to 5 weight percent based upon the total weight of the encapsulated treatment chemical. Encapsulated scale inhibitors may be commercially available through Baker Huges and ChampionX.

The encapsulant may be a permeable polymer. A permeable polymer is a polymer through which the treatment chemical is able to diffuse. The permeable polymer may have rigid, twisted macromolecular backbones that lead to microvoids. The microvoids may allow for the treatment chemical to diffuse from the encapsulant and into the fluid of the water supply well. The treatment chemical encapsulated may be released by diffusion through the permeable polymer membrane into the produced fluids of the water supply well. The permeable polymer may be carbohydrates (i.e., maltodextrin, starch, dextran, alginate, and chitosan), gums (i.e., Arabic gum, karaya gum, and xanthan gum), fibers (i.e., pectin and carrageenan), proteins (i.e., whey, casein, and gelatin), and waxes (i.e., beeswax).

Once the encapsulated treatment chemical has been placed in the permeable container, the method may then include placing the device in the water supply well, where the device includes a gauge hanger and at least one permeable container as previously described. The device may be deployed with a slickline or coil tubing. The gauge hanger deployment using a slickline is a conventional method to deploy a gauge hanger. The gauge hanger deployment may be run on the slickline or an electric cable or using standard setting tools. The gauge hanger may enable deploying on the slickline through narrow restrictions or smaller completion tubing and then setting in larger inner diameter liners and casings. The slickline may have a diameter of 0.092, 0.108, 0.125, 0.140, 0.150, and 0.160 inches. The slickline may have a length of 18,000, 20,000, 25,000 and 30,000 feet. The device may be placed at a predetermined depth in the water supply well. The predetermined depth may be determined by historical well log data or based on model predictions. Historical well data may be collected for corrosion measurements. The historical well data may indicate the loss of metal due to corrosion at different depths and may be independent for each well. The model predictions may be used to predict scale formation or corrosion occurrence. The models used are well known to those in the art and readily available. Examples of models may include ScaleSoftPitzer, developed by Rice University, for predicting the scale formation in downhole completion tubing. Another example may include Predict, developed by Honeywell, to predict corrosion. In one or embodiments, the predetermined depth is in a range of 200 to 7000 ft. For example, the desired depth may have a lower limit of one of any of 200, 500, 1000, 1500, 2000, 2500, 3000, and 3500 ft with an upper limit of one of any of 3500, 4000, 4500, 5000, 6000, and 7000 ft, where any lower limit may be combined with any mathematically compatible upper limit. The device may be placed below the predetermined depth to treat the water supply well. For example, if the historical well data or model prediction indicates that scale formation or corrosion may occur at 4000 ft, the device is placed below 4000 ft to dispense the treatment chemical and treat the water supply well at 4000 ft.

The permeable container may include a top portion with top openings, a bottom portion with bottom openings, and a connecting portion, as previously described. In one or more embodiments, the produced fluids from the water supply well flow in through the bottom openings and into the at least one permeable container to contact the encapsulated treatment chemical. The contact may result in the treatment chemical diffusing into the produced fluids. Then the produced fluids with the treatment chemical may flow out through the top openings and into the water supply well. The treatment chemical may be dispensed into the water supply well and thus may treat the well.

In one or more embodiments, the connecting portion includes openings, as previously described. Produced fluids from the water supply well may flow in through a combination of the bottom openings and the openings in the connecting portion to contact the encapsulated treatment chemical. The contact may result in the treatment chemical diffusing from the encapsulation into the produced fluids. Then, the produced fluids with the treatment chemical may flow out through the top openings and into the water supply well. The treatment chemical may be dispensed into the water supply well and thus may treat the well.

The method may then include treating a water supply by introducing the treatment chemical into the water supply. The treatment chemical may diffuse into the produced fluids of the water supply well, as described above. The concentration of the treatment chemical released from the at least one permeable container may be monitored from samples collected at the wellhead. Methods for measuring the concentration of the treatment chemical may include chromatography methods, Inductively Coupled Plasma techniques (including mass spectrometry and optical emission spectroscopy), or Ion Chromatography. The concentration of the treatment chemical in the samples may be in a range of 0.1 to 10 ppm.

In one or more embodiments, the device includes a gauge hanger and two permeable containers. The gauge hanger and two permeable containers are as previously described. A different encapsulated treatment chemical may be placed in each of the two permeable containers. For example, a first treatment chemical may be encapsulated and placed in the first permeable container, while a second treatment chemical different than the first treatment chemical may be encapsulated and placed in the second permeable container. The same encapsulated treatment chemical may also be placed in each of the two permeable containers. The encapsulated treatment chemical may be placed in the two permeable containers in the same manner as previously described for the at least one permeable container. The volume of encapsulated treatment chemical placed in each of the two permeable containers may depend on the dosage for each treatment chemical needed. The volume of encapsulated treatment chemical placed in each of the two permeable containers may be of a range from 0.618 to 74 L. For example, the volume of encapsulated treatment chemical in each of the two permeable containers may have a lower limit of one of any of 0.618, 1, 5, 10, 20, 30, and 37 L with an upper limit of one of any of 37, 40, 45, 50, 60, 70, and 74 L, where any lower limit may be combined with any mathematically compatible upper limit. In one or more embodiments, the volume of encapsulated treatment chemical is different in each of the two permeable containers.

The device including the gauge hanger and the at least one permeable container may be retrieved and refilled with the encapsulated treatment chemical. The need for retrieving and refilling the at least one permeable container may depend on the concentration of the treatment chemical. For example, if the concentration of the treatment chemical is below a desired dosage, the device will be retrieved and refilled. The concentration of the treatment chemical is measured as previously described. In one or more embodiments, the device will be retrieved and refilled when the concentration of the treatment chemical is below about 0.1 to 10 ppm.

Embodiments of the present disclosure may provide at least one of the following advantages. Effective control of downhole corrosion is technically challenging and expensive in water supply wells. Current methods of the art include continuous injection and bath treatment. Continuous injection of treatment chemicals may require high maintenance and installation of costly injection systems. Batch treatment with treatment chemicals may have a short treatment time period and waste a large quantity of chemicals. Batch treatment may also cause formation damage in depleted water supply wells. The device and method of treatment described herein is low maintenance, cost effective, and may be used in all types of wells.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A device for treating water supply wells, the device comprising:
a gauge hanger comprising an attachment piece at a bottom end of the gauge hanger; and
at least one permeable container connected to the gauge hanger via the attachment piece,
wherein the at least one permeable container comprises:
a top portion comprising top openings;
a bottom portion comprising bottom openings; and
a connecting portion connecting the top portion to the bottom portion.

2. The device of claim 1, wherein the attachment piece is a male screw and a female connector.

3. The device of claim 1, wherein a second permeable container is connected in series to the at least one permeable container via a second attachment piece.

4. The device of claim 1, wherein the top portion further comprises a density of 4 to 400 top openings per cm².

5. The device of claim 1, wherein the bottom portion further comprises a density of 4 to 400 bottom openings per cm².

6. The device of claim 1, wherein the connecting portion comprises side openings.

7. The device of claim 1, wherein the connecting portion comprises 4 to 400 side openings per cm².

8. The device of claim 1, wherein the connecting portion connects the top portion to the bottom portion to provide a length ranging from 1 to 30 ft.

9. The device of claim 1, wherein the at least one permeable container contains an encapsulated treatment chemical for treating water supply wells.

10. The device of claim 1, wherein the at least one permeable container is made of a corrosion resistant alloy.

11. The device of claim 10, wherein the corrosion resistant alloy is stainless steel.

12. A method for treating a water supply well, the method comprising:
placing an encapsulated treatment chemical in at least one permeable container;
placing a device in the water supply well, wherein the device comprises:
a gauge hanger; and
the at least one permeable container, wherein the at least one permeable container comprises:
a top portion with top openings;
a bottom portion with bottom openings, and
a connecting portion connecting the top portion to the bottom portion; and
treating a water supply by flowing produced fluid through the bottom openings and top openings, thereby introducing a treatment chemical into the water supply.

13. The method of claim 12, wherein a volume of the encapsulated treatment chemical is in a range of 0.618 to 74 L.

14. The method of claim 12, wherein the treatment chemical is selected from the group consisting of corrosion inhibitors, scale inhibitors, biocides, and combinations thereof.

15. The method of claim 14, wherein the treatment chemical is a corrosion inhibitor selected from the group consisting of imidazoline, imidazole, quinoline, pyridine, and their derivatives, primary/secondary/tertiary/quaternary amines, n-dodecylamine, N—N-dimethyl dodecylamine, amide, amidoamine, amidoimidazoline, isoxazolidine, succinic acid, carboxylic acid, aldehyde, alkanolamine, imidazoline-imidazolidine compound, α,β-ethylene unsaturated aldehyde, polyalkylenepolyamine, diethylenetriamine, and mixtures thereof.

16. The method of claim 12, wherein placing the device comprises a deployment of a gauge hanger by a slickline or a coil tubing.

17. The method of claim 12, wherein the device comprises two permeable containers in series.

18. The method of claim 17, wherein placing the encapsulated chemical treatment further comprises placing a different encapsulated treatment chemical in each of the two permeable containers.

19. The method of claim 16, further comprising retrieving and refilling the device from the water supply well with the encapsulated treatment chemical when a concentration of the treatment chemical is below 0.1 to 10 ppm.
